(19) United States
(12) Patent Application Publication
(10) Pub. No.: US 2025/0168538 A1
(43) Pub. Date: May 22, 2025

(54) OPTICAL PATH SWITCHING NODE, OPTICAL FIBER NETWORK AND TEST METHOD FOR THE OPTICAL FIBER NETWORK

(71) Applicant: NIPPON TELEGRAPH AND TELEPHONE CORPORATION, Tokyo (JP)

(72) Inventors: Kazuhide NAKAE, Musashino-shi, Tokyo (JP); Kazunori KATAYAMA, Musashino-shi, Tokyo (JP); Hiroshi WATANABE, Musashino-shi, Tokyo (JP); Tomohiro KAWANO, Musashino-shi, Tokyo (JP); Tatsuya FUJIMOTO, Musashino-shi, Tokyo (JP)

(73) Assignee: NIPPON TELEGRAPH AND TELEPHONE CORPORATION, Tokyo (JP)

(21) Appl. No.: 18/839,696

(22) PCT Filed: Mar. 2, 2022
(86) PCT No.: PCT/JP2022/008787

§ 371 Date: Aug. 19, 2024

(51) Int. Cl. H04Q 11/00; H04B 10/077; H04J 14/02

(52) U.S. Cl. CPC H04Q 11/0005; H04B 10/077; H04J 14/0283; H04Q 2011/0007

(57) ABSTRACT

The present disclosure is an optical path switching node including: a four-way optical switch capable of switching to any one of a first connection state in which a first port and a second port are connected internally, and a third port and a fourth port are connected internally, a second connection state in which the first port and the third port are connected internally, and the second port and the fourth port are connected internally, and a third connection state in which the first port and the fourth port are connected internally, and the second port and the third port are connected internally; a first optical coupler that couples test light to an optical path from the first port in an external direction of the four-way optical switch; a second optical coupler that couples test light to an optical path from the second port in an external direction of the four-way optical switch; a third optical coupler that couples test light to an optical path from the third port in an external direction of the four-way optical switch; and a fourth optical coupler that couples test light to an optical path from the fourth port in an external direction of the four-way optical switch.

### TECHNICAL FIELD

The present disclosure relates to an optical path switching node, an optical fiber network to which the optical path switching node is applied, and a method for testing the optical fiber network.

### BACKGROUND ART

In an access optical fiber network, a communication apparatus installed in a communication building and a user terminal installed in a user's house are connected by an optical fiber core wire, and optical path switching for changing a route of the optical fiber core wire is performed. A configuration of a four-way optical switch applied to an optical path switching node is illustrated in FIG. 1, and a configuration of an optical fiber network to which the four-way optical switch of FIG. 1 is applied and a test method thereof are illustrated in FIGS. 2 and 3 (see, for example, Non Patent Literature 1.).

In FIG. 1, reference numeral 10 denotes a four-way optical switch. The four-way optical switch 10 can be in three types of connection states. That is, it is possible to switch to any one of:
(1) a first connection state in which a first port P1 and a second port P2 are connected internally, and a third port P3 and a fourth port P4 are connected internally;
(2) a second connection state in which the first port P1 and the third port P3 are connected internally, and the second port P2 and the fourth port P4 are connected internally; and
(3) a third connection state in which the first port P1 and the fourth port P4 are connected internally, and the second port P2 and the third port P3 are connected internally.

In FIGS. 2 and 3, reference numeral 100 denotes a communication apparatus, reference numeral 101 denotes a wiring rack, reference numeral 102 denotes an upper loop, reference numerals 103-1, 103-2, and 103-3 denote lower loops, reference numeral 104 denotes a user terminal, and reference numerals 210-1, 210-2, and 210-3 denote optical path switching nodes. The four-way optical switch 10 described in FIG. 1 is disposed in each of the optical path switching nodes 210-1, 210-2, and 210-3. The first port P1 and the second port P2 of the four-way optical switch 10 are connected to an upper loop, and the third port P3 and the fourth port are connected to a lower loop.

In the optical fiber network illustrated in FIG. 2, in order to connect the communication apparatus 100 installed in a communication building and the user terminal 104 installed in user's house via the optical fiber network, the four-way optical switch of the optical path switching node 210-1 of the upper loop 102 is set to the first connection state, and the four-way optical switch of the optical path switching node 210-2 is set to the second connection state. An optical fiber route from the communication apparatus 100 passes through the optical path switching node 210-1 of the upper loop 102 via the wiring rack 101 in a communication building, is connected to the lower loop 103-2 at the optical path switching node 210-2, and reaches the user terminal 104.

In a test of the optical fiber network illustrated in FIG. 2, a method as illustrated in FIG. 3 is adopted. Test light having a wavelength different from that of communication (broken line in FIG. 3) is inserted from the wiring rack 101 of a communication building by wavelength multiplexing, and a section to the user terminal 104 via the optical path switching node 210-1 and the optical path switching node 210-2 of the upper loop 102, and the lower loop 103-2 is tested (see, for example, Non Patent Literature 2). Since the test light has a wavelength different from that of the communication light, the test can be performed without affecting communication even during communication between the communication apparatus 100 and the user terminal 104.

### CITATION LIST

### Non Patent Literature

Non Patent Literature 1: Tomohiro Kawano, Tatsuya Fujimoto, Kazuhide Nakae, Hiroshi Watanabe, and Kazunori Katayama, “Shourai hikari access mou ni muketa enkaku kouro kirikae node no kentou (in Japanese) (A Study on Remote Operated Optical Fiber Switching Node for Future Access Network)”, The Institute of Electronics, Information and Communication Engineers (IEICE) General Conference, 2021 B-13-16, 2021 Non Patent Literature 2: Hiroshi Watanabe, Tomohiro Kawano, Chisato Fukai, Ryo Koyama, Kazuhide Nakae, Tatsuya Fujimoto, Yoshiteru Abe, and Kazunori Katayama, “Tadan loop gata hikari access mou de unyou suru enkaku kouro kirikae node (in Japanese) (Remote Operated Optical Fiber Switching Node Operated in Optical Access Network based on Concatenated Loop Topology)”, The Institute of Electronics, Information and Communication Engineers (IEICE) Society Conference, 2021 BK-2-3, 2021

### SUMMARY OF INVENTION

### Technical Problem

However, in a configuration of the optical fiber network, a form as illustrated in FIG. 4 is also assumed. In FIG. 4, reference numeral 100 denotes a communication apparatus, reference numeral 101 denotes a wiring rack, reference numeral 102 denotes an upper loop, reference numerals 103-1, 103-2, and 103-3 denote lower loops, reference numerals 104-1 and 104-2 denote a user terminal, and reference numerals 210-1, 210-2, and 210-3 denote optical path switching nodes.

The four-way optical switch of the optical path switching node 210-2 is switched and connected to the third connection state, the four-way optical switch of the optical path switching node 210-3 is switched and connected to the second connection state, and the user terminal 104-1 and the user terminal 104-2 are directly connected without the optical fiber route passing through a communication building. The optical fiber route in this case is made of a section from the user terminal 104-1 of the lower loop 103-2 to the optical path switching node 210-2, a section from the optical path switching node 210-2 of the upper loop 102 to the optical path switching node 210-3, and a section from the optical path switching node 210-3 of the lower loop 103-3 to the user terminal 104-2.

In a test of the optical fiber network illustrated in FIG. 4, a method as illustrated in FIGS. 5 and 6 is assumed. In FIGS. 5 and 6, reference numeral 100 denotes a communication apparatus, reference numeral 101 denotes a wiring rack, reference numeral 102 denotes an upper loop, reference numerals 103-1, 103-2, and 103-3 denote lower loops, reference numerals 104-1 and 104-2 denote a user terminal, and reference numerals 210-1, 210-2, and 210-3 denote optical path switching nodes.

The test of the optical fiber network illustrated in FIG. 4 is performed by dividing into the following sections A and B.
Section A: Section from user terminal 104-1 to optical path switching node 210-2 of lower loop 103-2
Section B: Section from optical path switching node 210-2 to optical path switching node 210-3 of upper loop 102 and section from optical path switching node 210-3 to user terminal 104-2 of lower loop 103-3

As illustrated in FIG. 5, the test of the section A is performed in the following procedure.
1. The optical path switching node 210-2 is switched to the second connection state.
2. Test light (broken line in FIG. 5) is inserted from the wiring rack 101 of the communication building, and the optical fiber in the section A is tested via the upper loop 102.

As illustrated in FIG. 6, the test of the section B is performed by the following procedure.
1. The optical path switching node 210-2 is switched to the first connection state.
2. Test light (broken line in FIG. 6) is inserted from the wiring rack 101 of the communication building, and the optical fiber in the section B is tested via the upper loop 102.

In order to perform the test of the optical fiber network by the above procedure, it is necessary to switch the optical path switching node 210-2 from the third connection state of the communication state to the second connection state or the first connection state, and thus communication between the user terminal 104-1 and the user terminal 104-2 is interrupted. In a case where communication is interrupted, approval from a user is required. Even if permission is obtained from the user, the optical path switching node 210-2 is switched and tested a plurality of times, and the optical path switching node 210-2 is switched back after the test, and thus there is a concern that a communication interruption state may be prolonged.

An object of the present disclosure is to provide an optical path switching node that enables a test of an optical fiber network without interruption of communication, an optical fiber network to which the optical path switching node is applied, and a method for testing the optical fiber network.

### Solution to Problem

The optical path switching node of the present disclosure includes an optical coupler that couples test light, thereby enabling a test of an optical fiber network without interruption of communication.

Specifically, an optical path switching node of the present disclosure includes:
a four-way optical switch capable of switching to any one of
a first connection state in which a first port and a second port are connected internally, and a third port and a fourth port are connected internally,
a second connection state in which the first port and the third port are connected internally, and the second port and the fourth port are connected internally, and
a third connection state in which the first port and the fourth port are connected internally, and the second port and the third port are connected internally;
a first optical coupler that couples test light to an optical path from the first port in an external direction of the four-way optical switch;
a second optical coupler that couples test light to an optical path from the second port in an external direction of the four-way optical switch;
a third optical coupler that couples test light to an optical path from the third port in an external direction of the four-way optical switch; and
a fourth optical coupler that couples test light to an optical path from the fourth port in an external direction of the four-way optical switch.

Specifically, the optical path switching node of the present disclosure further includes:
a test light switch that switches and connects the test light to any one of the first optical coupler, the second optical coupler, the third optical coupler, and the fourth optical coupler.

An optical fiber network of the present disclosure includes the optical path switching node of the present disclosure, thereby enabling a test of an optical fiber network without interruption of communication.

Specifically, an optical fiber network of the present disclosure includes:
the optical path switching node described above;
a first optical fiber connected to the first port via the first optical coupler;
a second optical fiber connected to the second port via the second optical coupler;
a third optical fiber connected to the third port via the third optical coupler; and
a fourth optical fiber connected to the fourth port via the fourth optical coupler.

Specifically, the optical fiber network of the present disclosure further includes:
a fifth optical fiber that inputs test light in an external direction of the four-way optical switch to the first optical coupler;
a sixth optical fiber that inputs test light in an external direction of the four-way optical switch to the second optical coupler;
a seventh optical fiber that inputs test light in an external direction of the four-way optical switch to the third optical coupler; and
an eighth optical fiber that inputs test light in an external direction of the four-way optical switch to the fourth optical coupler.

Specifically, an optical fiber network of the present disclosure includes:
the optical path switching node described above;
a first optical fiber connected to the first port via the first optical coupler;
a second optical fiber connected to the second port via the second optical coupler;
a third optical fiber connected to the third port via the third optical coupler; and
a fourth optical fiber connected to the fourth port via the fourth optical coupler.

Specifically, the optical fiber network of the present disclosure, further includes:
a ninth optical fiber that inputs test light to the test light switch.

A method for testing an optical fiber network of the present disclosure enables a test of an optical fiber network without interruption of communication, by using the optical path switching node of the present disclosure.

Specifically, the method for testing an optical fiber network of the present disclosure includes:
inputting test light to at least one of the fifth optical fiber, the sixth optical fiber, the seventh optical fiber, and the eighth optical fiber of the optical fiber network described above; and testing any of a first optical fiber, a second optical fiber, a third optical fiber, and a fourth optical fiber corresponding thereto.

Specifically, the method for testing an optical fiber network of the present disclosure includes:
inputting test light to the ninth optical fiber of the optical fiber network described above; and
testing any of a first optical fiber, a second optical fiber, a third optical fiber, and a fourth optical fiber switched and connected by the test light switch.

Note that the inventions of each disclosure above can be combined as far as possible.

### Advantageous Effects of Invention

According to the present disclosure, it is possible to provide an optical path switching node that enables a test of an optical fiber network without interruption of communication, an optical fiber network to which the optical path switching node is applied, and a method for testing the optical fiber network.

### BRIEF DESCRIPTION OF DRAWINGS

FIG. 1 illustrates a configuration of a four-way optical switch applied to an optical path switching node.

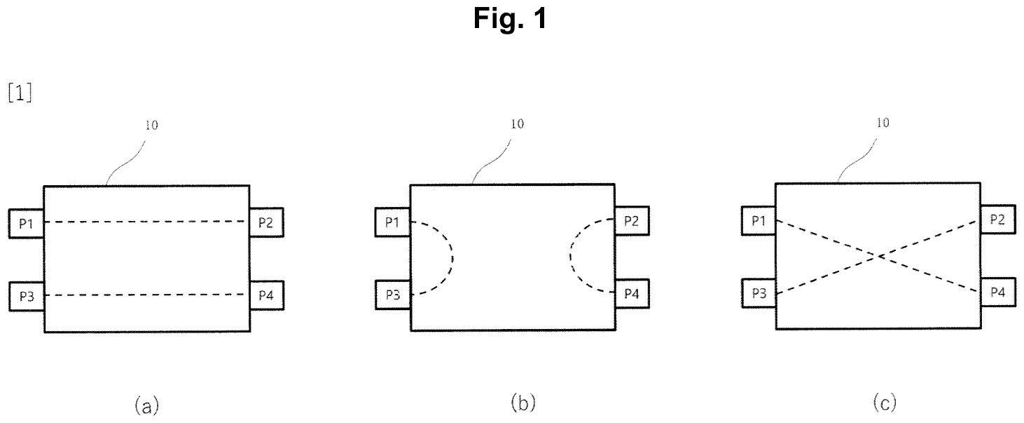

FIG. 2 illustrates an example of a configuration of an optical fiber network.

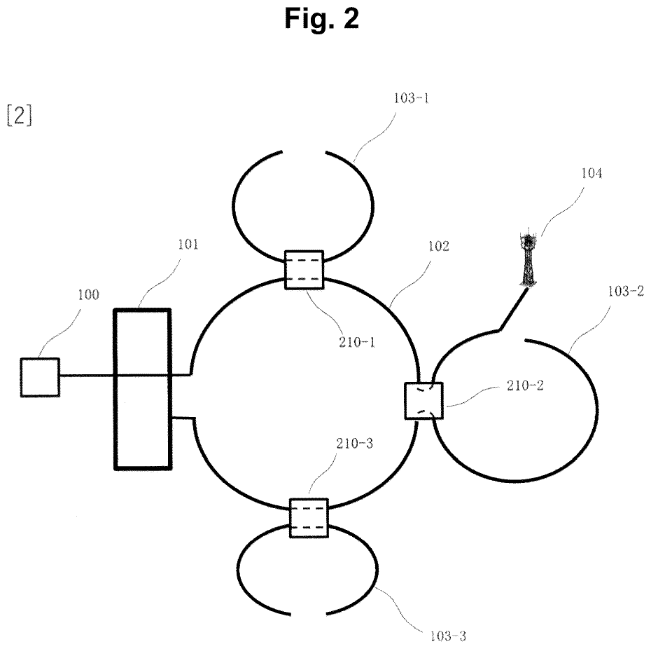

FIG. 3 illustrates an example of a test of an optical fiber network.

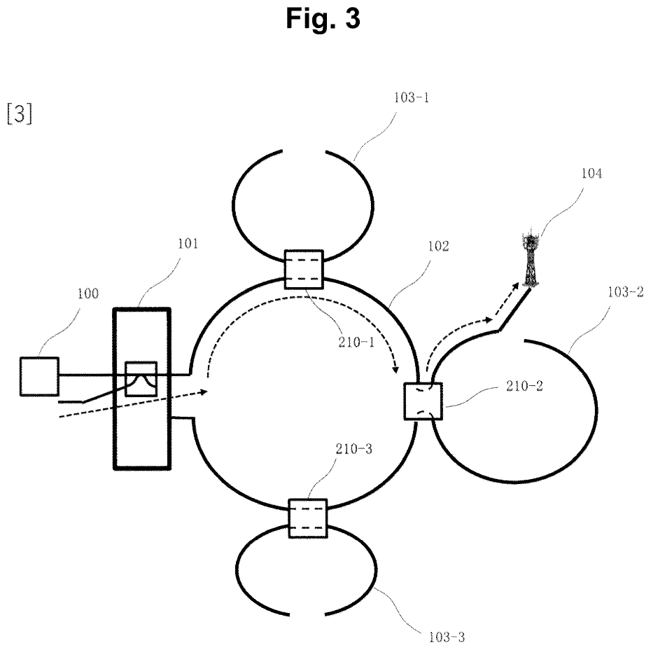

FIG. 4 illustrates an example of a configuration of an optical fiber network.

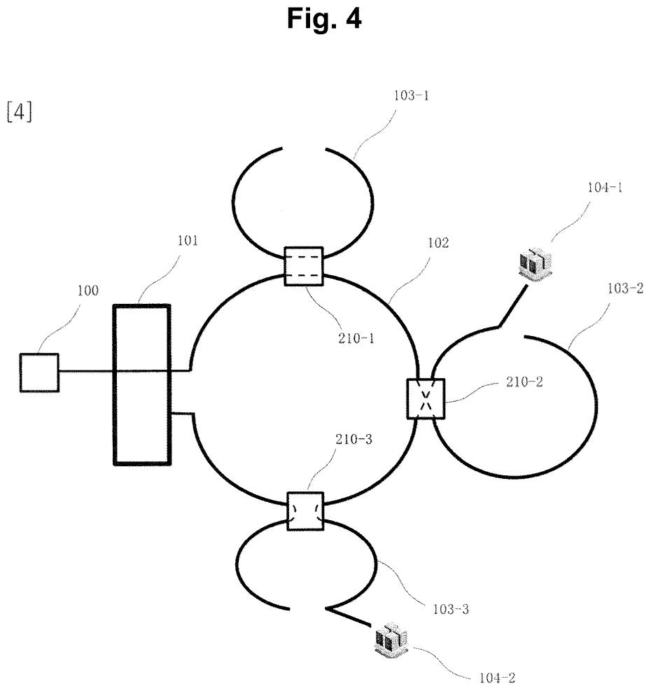

FIG. 5 illustrates an example of a test of an optical fiber network.

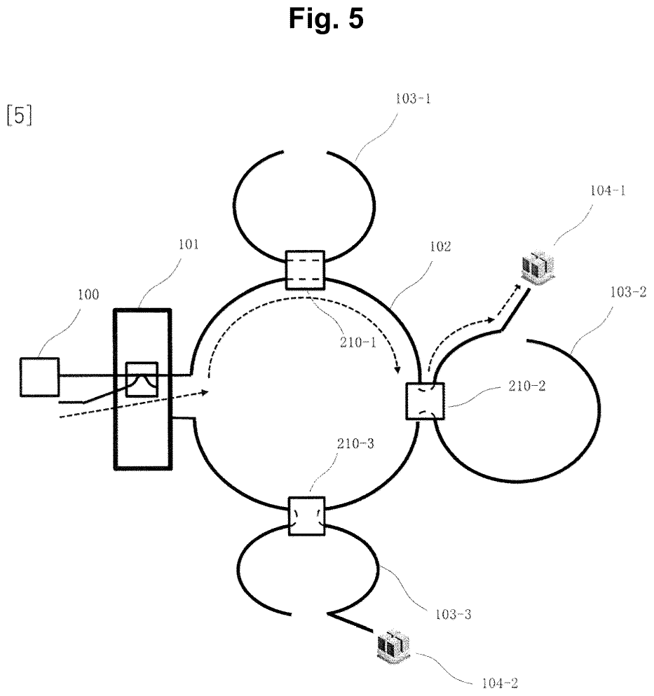

FIG. 6 illustrates an example of a test of an optical fiber network.

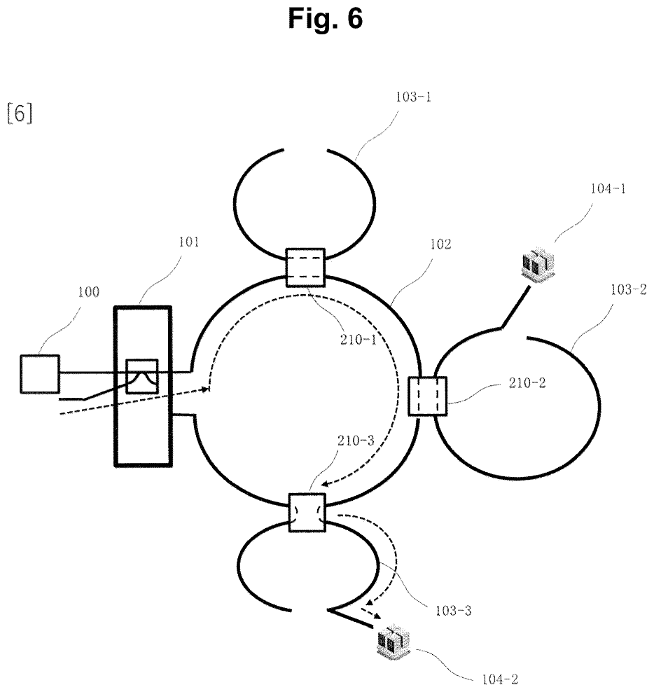

FIG. 7 illustrates an example of a configuration of an optical path switching node.

FIG. 8 illustrates an example of a configuration of a four-way optical switch.

FIG. 9 illustrates an example of a configuration of an optical path switching node.

FIG. 10 illustrates an example of a test of an optical fiber network.

FIG. 11 illustrates an example of a test of an optical fiber network.

FIG. 12 illustrates an example of a test of an optical fiber network.

### DESCRIPTION OF EMBODIMENTS

Hereinafter, embodiments of the present disclosure will be described in detail with reference to the drawings. Note that the present disclosure is not limited to the following embodiments. These embodiments are merely examples, and the present disclosure can be implemented in a form with various modifications and improvements based on the knowledge of those skilled in the art. Note that components having the same reference numerals in the present specification and the drawings indicate the same components.

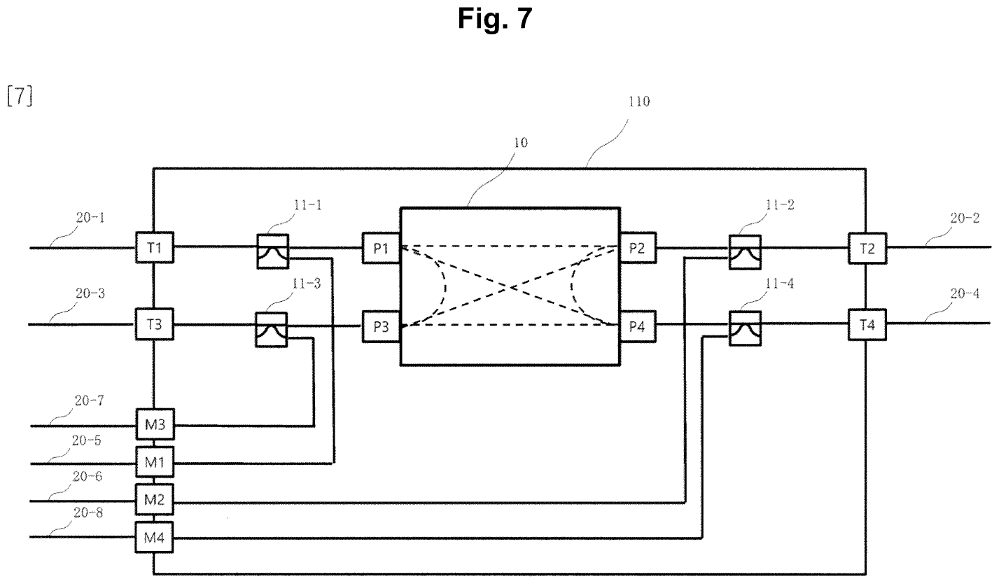

FIG. 7 illustrates a configuration of an optical path switching node and an optical fiber network of the present disclosure. In FIG. 7, reference numeral 10 denotes a four-way optical switch, reference numeral 11-1 denotes a first optical coupler, reference numeral 11-2 denotes a second optical coupler, reference numeral 11-3 denotes a third optical coupler, reference numeral 11-4 denotes a fourth optical coupler, reference numeral 20-1 denotes a first optical fiber, reference numeral 20-2 denotes a second optical fiber, reference numeral 20-3 denotes a third optical fiber, reference numeral 20-4 denotes a fourth optical fiber, reference numeral 20-5 denotes a fifth optical fiber, reference numeral 20-6 denotes a sixth optical fiber, reference numeral 20-7 denotes a seventh optical fiber, reference numeral 20-8 denotes an eighth optical fiber, and reference numeral 110 denotes an optical path switching node.

In FIG. 7, the four-way optical switch 10 can be in three types of connection states. That is, it is possible to switch to any one of:
(1) a first connection state in which a first port P1 and a second port P2 are connected internally, and a third port P3 and a fourth port P4 are connected internally;
(2) a second connection state in which the first port P1 and the third port P3 are connected internally, and the second port P2 and the fourth port P4 are connected internally; and
(3) a third connection state in which the first port P1 and the fourth port P4 are connected internally, and the second port P2 and the third port P3 are connected internally.

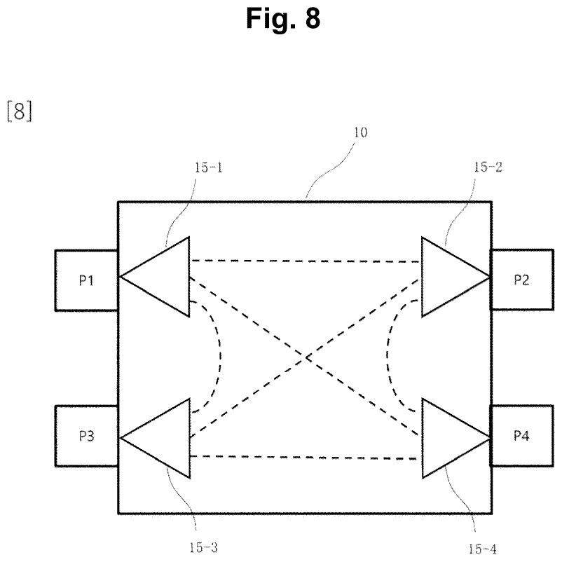

FIG. 8 illustrates a configuration example of the four-way optical switch 10. In FIG. 8, reference numerals 15-1, 15-2, 15-3, and 15-4 denote 1×3 optical switches. The 1×3 optical switch 15-1 can switch an optical path to any of other 1×3 optical switches 15-2, 15-3, and 15-4. The same applies to the 1×3 optical switches 15-2, 15-3, and 15-4. By switching the optical paths of the 1×3 optical switches 15-1, 15-2, 15-3, and 15-4, the four-way optical switch 10 can be in three types of connection states. Examples of the 1×3 optical switch include a mechanical optical switch and a MEMS optical switch.

In FIG. 7, the optical path switching node 110 further includes: in addition to the four-way optical switch 10, a first optical coupler 11-1 that couples test light to an optical path from the first port P1 in an external direction of the four-way optical switch 10; a second optical coupler 11-2 that couples the test light to the optical path from the second port P2 in an external direction of the four-way optical switch 10; a third optical coupler 11-3 that couples the test light to the optical path from the third port P3 in an external direction of the four-way optical switch 10; and a fourth optical coupler 11-4 that couples the test light to the optical path from the fourth port P4 in an external direction of the four-way optical switch 10.

The test light input from a test terminal M1 is coupled by the first optical coupler 11-1 and output from a communication terminal T1. The test light input from test terminals M2, M3, and M4 are coupled by the second optical coupler 11-2, the third optical coupler 11-3, and the fourth optical coupler 11-4, and output from communication terminals T2, T3, and T4, respectively.

An optical fiber coupler or an optical waveguide coupler can be applied to the first optical coupler 11-1, the second optical coupler 11-2, the third optical coupler 11-3, and the fourth optical coupler 11-4. It is preferable that a non-reflective terminator is attached to an end point to which the optical path of the optical couplers is not connected. This is to prevent unnecessary reflection at the time of testing the optical fiber.

In FIG. 7, the optical fiber network of the present disclosure includes an optical path switching node 110, a first optical fiber 20-1 connected to the first port P1 via the first optical coupler 11-1, a second optical fiber 20-2 connected to the second port P2 via the second optical coupler 11-2, a third optical fiber 20-3 connected to the third port P3 via the third optical coupler 11-3, and a fourth optical fiber 20-4 connected to the fourth port P4 via the fourth optical coupler 11-4. These are communication optical fibers.

In FIG. 7, the first optical fiber 20-1 is terminated at the communication terminal T1, and the communication terminal T1 and the first port P1 are connected via the first optical coupler 11-1. The second optical fiber 20-2 is terminated at the communication terminal T2, and the communication terminal T2 and the second port P2 are connected via the second optical coupler 11-2. The third optical fiber 20-3 is terminated at the communication terminal T3, and the communication terminal T3 and the third port P3 are connected via the third optical coupler 11-3. The fourth optical fiber 20-4 is terminated at the communication terminal T4, and the communication terminal T4 and the fourth port P4 are connected via the fourth optical coupler 11-4.

In FIG. 7, the optical fiber network of the present disclosure may further include a fifth optical fiber 20-5 that inputs test light in an external direction of the four-way optical switch 10 to the first optical coupler 11-1, a sixth optical fiber 20-6 that inputs test light in an external direction of the four-way optical switch 10 to the second optical coupler 11-2, a seventh optical fiber 20-7 that inputs test light in an external direction of the four-way optical switch 10 to the third optical coupler 11-3, and an eighth optical fiber 20-8 that inputs test light in an external direction of the four-way optical switch 10 to the fourth optical coupler 11-4. These are test optical fibers.

In FIG. 7, the fifth optical fiber 20-5 is terminated at the test terminal M1, and the test terminal M1 and the communication terminal T1 are connected via the first optical coupler 11-1. The sixth optical fiber 20-6 is terminated at the test terminal M2, and the test terminal M2 and the communication terminal T2 are connected via the second optical coupler 11-2. The seventh optical fiber 20-7 is terminated at the test terminal M3, and the test terminal M3 and the communication terminal T3 are connected via the third optical coupler 11-3. The eighth optical fiber 20-8 is terminated at the test terminal M4, and the test terminal M4 and the communication terminal T4 are connected via the fourth optical coupler 11-4.

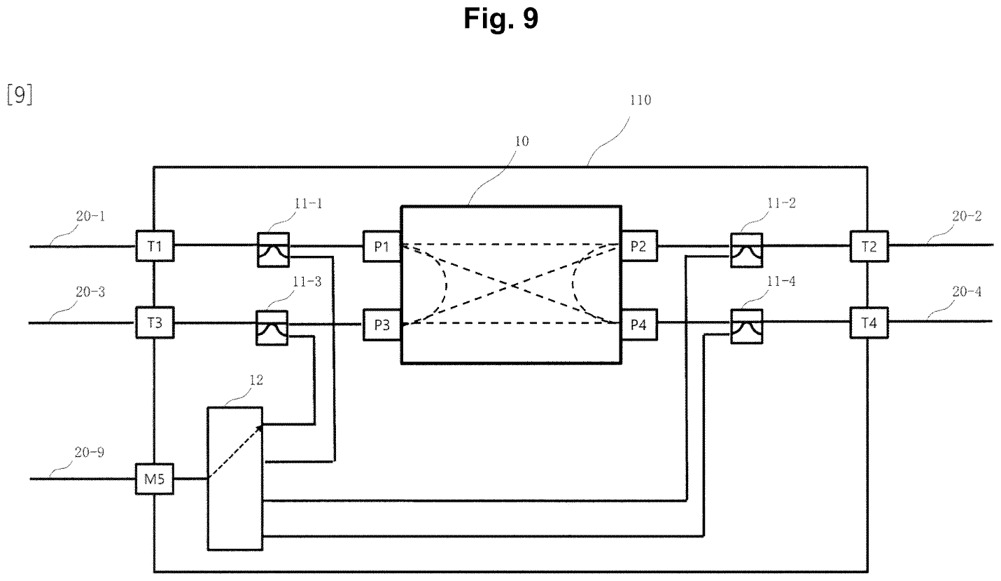

FIG. 9 illustrates another configuration of the optical path switching node and the optical fiber network of the present disclosure. In FIG. 9, reference numeral 10 denotes a four-way optical switch, reference numeral 11-1 denotes a first optical coupler, reference numeral 11-2 denotes a second optical coupler, reference numeral 11-3 denotes a third optical coupler, reference numeral 11-4 denotes a fourth optical coupler, reference numeral 12 denotes a test light switch, reference numeral 20-1 denotes a first optical fiber, reference numeral 20-2 denotes a second optical fiber, reference numeral 20-3 denotes a third optical fiber, reference numeral 20-4 denotes a fourth optical fiber, reference numeral 20-9 denotes a ninth optical fiber, and reference numeral 110 denotes an optical path switching node.

A difference from the optical path switching node illustrated in FIG. 7 is that the optical path switching node 110 of the present disclosure further includes a test light switch 12 that switches and connects the test light to any of the first optical coupler 11-1, the second optical coupler 11-2, the third optical coupler 11-3, and the fourth optical coupler 11-4. The test light input from the test terminal M5 is switched by the test light switch 12, coupled by any of the first optical coupler 11-1, the second optical coupler 11-2, the third optical coupler 11-3, and the fourth optical coupler 11-4, and output from any of the communication terminals T1, T2, T3, and T4. As compared with the optical path switching node illustrated in FIG. 7, in the optical path switching node 110 of the present disclosure, the number of test optical fibers to which the test light is input can be reduced.

In FIG. 9, the optical fiber network of the present disclosure includes an optical path switching node 110, a first optical fiber 20-1 connected to the first port P1 via the first optical coupler 11-1, a second optical fiber 20-2 connected to the second port P2 via the second optical coupler 11-2, a third optical fiber 20-3 connected to the third port P3 via the third optical coupler 11-3, and a fourth optical fiber 20-4 connected to the fourth port P4 via the fourth optical coupler 11-4. These are communication optical fibers.

In FIG. 9, the first optical fiber 20-1 is terminated at the communication terminal T1, and the communication terminal T1 and the first port P1 are connected via the first optical coupler 11-1. The second optical fiber 20-2 is terminated at the communication terminal T2, and the communication terminal T2 and the second port P2 are connected via the second optical coupler 11-2. The third optical fiber 20-3 is terminated at the communication terminal T3, and the communication terminal T3 and the third port P3 are connected via the third optical coupler 11-3. The fourth optical fiber 20-4 is terminated at the communication terminal T4, and the communication terminal T4 and the fourth port P4 are connected via the fourth optical coupler 11-4.

The optical fiber network of the present disclosure may further include a ninth optical fiber 20-9 that inputs the test light to the test light switch 12. The ninth optical fiber 20-9 is a test optical fiber. In FIG. 9, the ninth optical fiber 20-9 is terminated at the test terminal M5. The test light from the ninth optical fiber 20-9 is input to the test light switch 12, is switched and connected to any of the first optical coupler 11-1, the second optical coupler 11-2, the third optical coupler 11-3, and the fourth optical coupler 11-4, and is coupled in an external direction by any one thereof.

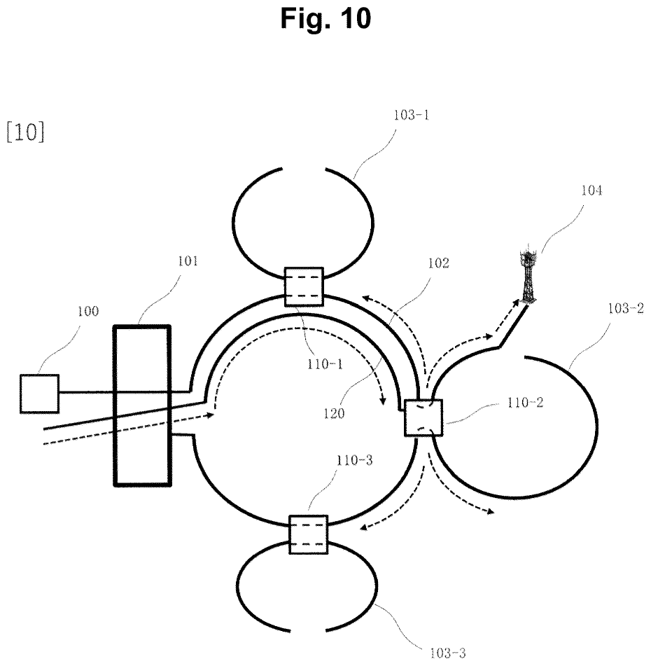

FIGS. 10, 11, and 12 illustrate a method for testing an optical fiber network of the present disclosure. In FIGS. 10, 11, and 12, reference numeral 100 denotes a communication apparatus, reference numeral 101 denotes a wiring rack, reference numeral 102 denotes an upper loop, reference numerals 103-1, 103-2, and 103-3 denote lower loops, reference numerals 104-1 and 104-2 denote a user terminal, reference numerals 110-1, 110-2, and 110-3 denote optical path switching nodes, and reference numeral 120 denotes a test optical fiber.

For the optical path switching node 110-2 of FIGS. 10, 11, and 12, the first optical fiber 20-1 illustrated in FIG. 7 or 9 corresponds to an optical fiber in a direction from the optical path switching node 110-2 of the upper loop 102 to the optical path switching node 110-3, the second optical fiber 20-2 corresponds to an optical fiber in a direction from the optical path switching node 110-2 of the upper loop 102 to the optical path switching node 110-1, the third optical fiber 20-3 corresponds to a counterclockwise optical fiber in the drawing from the optical path switching node 110-2 of the lower loop 103-2, and the fourth optical fiber 20-4 corresponds to a clockwise optical fiber in the drawing from the optical path switching node 110-2 of the lower loop 103-2.

In FIGS. 10, 11, and 12, if the optical path switching node 110-2 has the configuration illustrated in FIG. 7, any one selected from the fifth optical fiber 20-5, the sixth optical fiber 20-6, the seventh optical fiber 20-7, and the eighth optical fiber 20-8 illustrated in FIG. 7 corresponds to the test optical fiber 120. In FIGS. 10, 11, and 12, if the optical path switching node 110-2 has the configuration illustrated in FIG. 9, the ninth optical fiber 20-9 illustrated in FIG. 9 corresponds to the test optical fiber 120.

In FIG. 10, test light (broken line in FIG. 10) is input from the wiring rack 101 of the communication building to the optical path switching node 110-2 via the test optical fiber 120. The test light input to the optical path switching node 110-2 is input to any one of corresponding first optical fiber 20-1, second optical fiber 20-2, third optical fiber 20-3, and fourth optical fiber 20-4 by any one of first optical coupler 11-1, the second optical coupler 11-2, the third optical coupler 11-3, and the fourth optical coupler 11-4 provided in the optical path switching node 110-2. Examples of the test of an optical fiber network can include an optical time domain reflectometry (OTDR) and an optical frequency domain reflectometry (OFDR).

Therefore, according to the method for testing an optical fiber network of the present disclosure, the first optical fiber 20-1, the second optical fiber 20-2, the third optical fiber 20-3, and the fourth optical fiber 20-4 can be tested without depending on the connection state of the four-way optical switch 10. When a wavelength of the test light is set to be different from a wavelength of the communication light, the optical fiber network can be tested without interruption of communication.

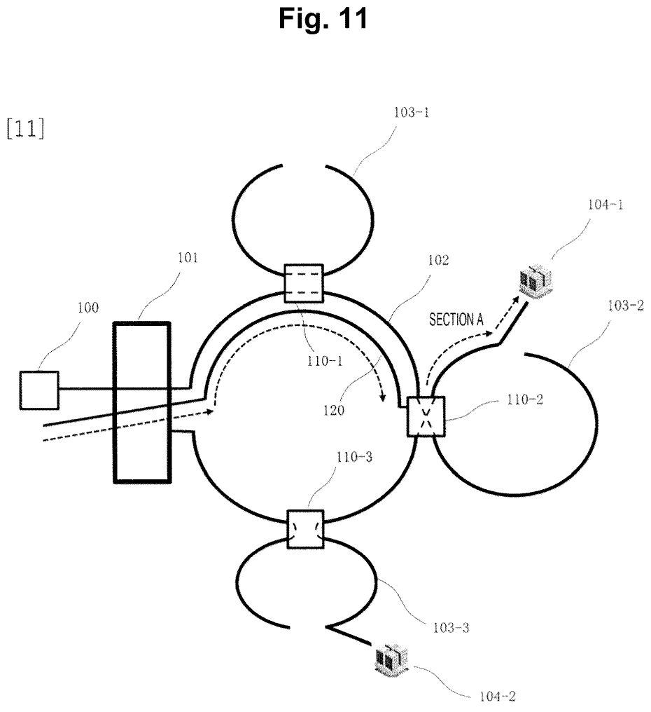

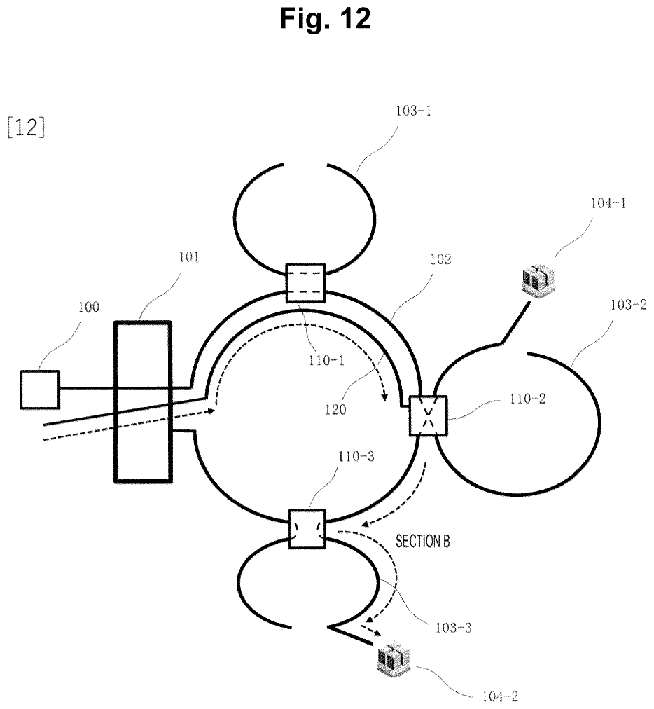

In FIGS. 11 and 12, the four-way optical switch of the optical path switching node 210-2 is switched and connected to the third connection state, the four-way optical switch of the optical path switching node 210-3 is switched and connected to the second connection state, and the user terminal 104-1 and the user terminal 104-2 are directly connected without the optical fiber route passing through a communication building. The optical fiber route in this case is made of a section from the user terminal 104-1 of the lower loop 103-2 to the optical path switching node 210-2, a section from the optical path switching node 210-2 of the upper loop 102 to the optical path switching node 210-3, and a section from the optical path switching node 210-3 of the lower loop 103-3 to the user terminal 104-2.

In a test of such an optical fiber network, a method as illustrated in FIGS. 11 and 12 is assumed. The test of the optical fiber network illustrated in FIGS. 11 and 12 is performed by dividing into the following sections A and B.
Section A: Section from user terminal 104-1 to optical path switching node 210-2 of lower loop 103-2
Section B: Section from optical path switching node 210-2 to optical path switching node 210-3 of upper loop 102 and section from optical path switching node 210-3 to user terminal 104-2 of lower loop 103-3

In the test in the section A, as illustrated in FIG. 11, test light (broken line in FIG. 11) is input from the wiring rack 101 of the communication building to the test optical fiber 121, and the optical fiber network in the section A is tested. In the test in the section B, as illustrated in FIG. 12, test light (broken line in FIG. 12) is input from the wiring rack 101 of the communication building to the test optical fiber 121, and the optical fiber network in the section B is tested. An order of the test of the section A and the test of the section B is not limited.

In FIGS. 11 and 12, if the optical path switching node 110-2 has the configuration illustrated in FIG. 7, the eighth optical fiber 20-8 corresponds to the test optical fiber 120 in the test of the section A. In the test of the section B, the fifth optical fiber 20-5 corresponds to the test optical fiber 120. In FIGS. 11 and 12, if the optical path switching node 110-2 has the configuration illustrated in FIG. 9, the ninth optical fiber 20-9 corresponds to the test optical fiber 120 in both the test of the section A and the test of the section B, and the test light switch 12 switches and connects the optical path from the ninth optical fiber to the fourth optical coupler 11-4 in the case of the section A and to the first optical coupler 11-1 in the case of the section B.

Therefore, according to the method for testing an optical fiber network of the present disclosure, even in a case where the user terminal is directly connected, the optical fiber network can be tested without depending on the connection state of the four-way optical switch 10. When a wavelength of the test light is set to be different from a wavelength of the communication light, the optical fiber network can be tested without interruption of communication.

As described above, the present disclosure is possible to provide an optical path switching node that enables a test of an optical fiber network without interruption of communication, an optical fiber network to which the optical path switching node is applied, and a method for testing the optical fiber network.

### INDUSTRIAL APPLICABILITY

The present disclosure can be applied to an information communication industry.

### REFERENCE SIGNS LIST

10 Four-way optical switch
11-1 First optical coupler
11-2 Second optical coupler
11-3 Third optical coupler
11-4 Fourth optical coupler
12 Test light switch
15-1, 15-2, 15-3, and 15-4 1×3 Optical switch
20-1 First optical fiber
20-2 Second optical fiber
20-3 Third optical fiber
20-4 Fourth optical fiber
20-5 Fifth optical fiber
20-6 Sixth optical fiber
20-7 Seventh optical fiber
20-8 Eighth optical fiber
20-9 Ninth optical fiber
100 Communication apparatus
101 Wiring rack
102 Upper loop
103-1, 103-2, and 103-3 Lower loop
104-1, 104-2 User terminal
110-1, 110-2, and 110-3 Optical path switching node
120 Test optical fiber

1. An optical path switching node comprising:
a four-way optical switch capable of switching to any one of
a first connection state in which a first port and a second port are connected internally, and a third port and a fourth port are connected internally,
a second connection state in which the first port and the third port are connected internally, and the second port and the fourth port are connected internally, and
a third connection state in which the first port and the fourth port are connected internally, and the second port and the third port are connected internally;
a first optical coupler that couples test light to an optical path from the first port in an external direction of the four-way optical switch;
a second optical coupler that couples test light to an optical path from the second port in an external direction of the four-way optical switch;
a third optical coupler that couples test light to an optical path from the third port in an external direction of the four-way optical switch; and
a fourth optical coupler that couples test light to an optical path from the fourth port in an external direction of the four-way optical switch.

2. The optical path switching node according to claim 1, further comprising: a test light switch that switches and connects the test light to any one of the first optical coupler, the second optical coupler, the third optical coupler, and the fourth optical coupler.

3. An optical fiber network comprising:
the optical path switching node according to claim 1;
a first optical fiber connected to the first port via the first optical coupler;
a second optical fiber connected to the second port via the second optical coupler;
a third optical fiber connected to the third port via the third optical coupler; and
a fourth optical fiber connected to the fourth port via the fourth optical coupler.

4. The optical fiber network according to claim 3, further comprising:
a fifth optical fiber that inputs test light in an external direction of the four-way optical switch to the first optical coupler;
a sixth optical fiber that inputs test light in an external direction of the four-way optical switch to the second optical coupler;
a seventh optical fiber that inputs test light in an external direction of the four-way optical switch to the third optical coupler; and
an eighth optical fiber that inputs test light in an external direction of the four-way optical switch to the fourth optical coupler.

5. An optical fiber network comprising:
the optical path switching node according to claim 2;
a first optical fiber connected to the first port via the first optical coupler;
a second optical fiber connected to the second port via the second optical coupler;
a third optical fiber connected to the third port via the third optical coupler; and
a fourth optical fiber connected to the fourth port via the fourth optical coupler.

6. The optical fiber network according to claim 5, further comprising: a ninth optical fiber that inputs test light to the test light switch.

7. A method for testing optical fiber network, comprising: inputting test light to at least one of the fifth optical fiber, the sixth optical fiber, the seventh optical fiber, and the eighth optical fiber of the optical fiber network according to claim 4; and
testing any of a first optical fiber, a second optical fiber, a third optical fiber, and a fourth optical fiber corresponding thereto.

8. A method for testing an optical fiber network, comprising: inputting test light to the ninth optical fiber of the optical fiber network according to claim 6; and testing any of a first optical fiber, a second optical fiber, a third optical fiber, and a fourth optical fiber switched and connected by the test light switch.
